(19) United States
(12) Patent Application Publication
(10) Pub. No.: US 2026/0141167 A1
(43) Pub. Date: May 21, 2026

(54) GENERATIVE TEXT FILLING

(71) Applicant: Adobe Inc., San Jose, CA (US)

(72) Inventors: Frederic Claude Thevenet, San Francisco, CA (US); Sunil Dhananjay Abhyankar, San Jose, CA (US); Raghav Kapoor, Sunnyvale, CA (US); Mengxiao Du, Sunnyvale, CA (US)

(73) Assignee: Adobe Inc., San Jose, CA (US)

(21) Appl. No.: 18/948,627

(22) Filed: Nov. 15, 2024

(51) Int. Cl. G06F 40/166; G06F 3/0481; G06F 3/04845; G06F 40/109

(52) U.S. Cl. CPC G06F 40/166; G06F 3/0481; G06F 3/04845; G06F 40/109

(57) ABSTRACT

In implementations of techniques and systems for generative text filling, a processing device implements a text generation service to receive an input that includes a text input indicating example language or content for the text response and one or more dimensions of a text box. The processing device receives the text input and one or more dimensions via a user interface. The text generation service generates a prompt for a machine-learning model based on the text input and one or more dimensions. The processing device uses the machine-learning model to generate the text response based on the prompt for the text box with a character length corresponding to the one or more dimensions of the text box. The processing device then causes the generated text response to be presented to a user inside the text box via the user interface.

### BACKGROUND

Digital content creators employ text boxes to prepare digital content with textual descriptions. The textual descriptions provide informative descriptions, mathematical concepts, numerical data, and/or creative expressions. Users often use machine-learning models to create or edit text within a text box. The generated text, however, often does not fit within the desired text box because it is too long or too short. Users then iteratively re-prompt the machine-learning models until a response is generated that fits. Although conventional generative machine-learning models support generating longer or shorter responses, these models lead to a repetitive and imprecise “best guess” approach that falls short of the desires of many content creators and inefficient use of computational resources.

### SUMMARY

Techniques and systems for generative text filling are described. In one example, a processing device receives via a user interface a request for text generation within a text box that includes textual details for the generated response and dimensions of the text box. For example, the user drags handles associated with a text box filled with initial text to prompt the processing device to automatically expand or contract the initial text to fit the new dimensions of the text box. In another example, the user creates a text box for insertion in digital content and provides an audio or textual prompt for the processing device to generate text to fit the text box dimensions.

The processing device then generates a prompt based on the text input (e.g., initial text or an initial prompt for a generative model) and the one or more dimensions, which correspond to the characters that can fit inside the text box, using a machine-learning model. The processing device uses the machine-learning model to generate a text response with a character length corresponding to one or more text box dimensions associated with the dimensions, which is output as generated text inside the text box via the user interface.

This Summary introduces a simplified selection of concepts that are further described below in the Detailed Description. As such, this Summary is not intended to identify essential features of the claimed subject matter or to aid in determining its scope.

### BRIEF DESCRIPTION OF THE DRAWINGS

The detailed description is described with reference to the accompanying figures Entities represented in the figures are indicative of one or more entities, and thus, reference is made interchangeably to single or plural forms of the entities in the discussion.

FIG. 1 illustrates a digital medium environment in an example implementation that is operable to employ generative text filling as described herein.

FIG. 2 depicts a system in an example implementation showing operation of a text generation service of FIG. 1 in greater detail as employing the techniques described herein.

FIG. 3 depicts examples of different factors the character number estimator considers to determine the number of characters within a bounding box.

FIG. 4 depicts a system and procedure in an example implementation showing an operation of a character number estimator of FIG. 2 in greater details as employing the techniques described herein.

FIG. 5 depicts a system and procedure in an example implementation showing an operation of a prompt generation module of FIG. 2 in greater detail as employing the techniques described herein.

FIG. 6 depicts a system and procedure in an example implementation showing an operation of a variable response module of FIG. 2 in greater detail as employing the techniques described herein.

FIG. 7 illustrates an example of an initial response and response variations to generate a text output that fits a text box in accordance with techniques described herein.

FIG. 8 is a flow diagram depicting an algorithm as a step-by-step procedure in an example implementation of operations performable for training a machine-learning model of the machine-learning system of FIG. 1.

FIG. 9 is a flow diagram depicting a procedure in an example implementation in which generative text filling is performed.

FIG. 10 illustrates an example system with an example computing device representative of one or more computing systems and/or devices usable to implement the techniques described herein.

### DETAILED DESCRIPTION

### Overview

Creating compelling text to accompany digital media is often daunting and time-consuming. Some conventional content creation services offer artificial intelligence tools to generate text. Although users may request shorter or longer responses or responses of a certain length, these conventional tools struggle to generate text responses that fit within text boxes (e.g., with a predetermined width and height) defined by the user. As a result, users often iteratively submit new or edited prompts to these conventional services until a text with the correct size is generated or manually edit the responses themselves. To overcome these and other limitations of conventional approaches, techniques and systems are described herein for generative text filling to provide text responses that fit a user-adjustable text box.

A conventional approach for generating text for a user-defined bounding box is to manually prompt a machine-learning model to generate a new response and then copy and paste that text into the bounding box. If the generated response does not fit well within the bounding box, users can manually edit the generated text or iteratively instruct the machine-learning model to generate a shorter or longer response. While maximum tokens (e.g., word or character limits) may be used to cap generated outputs, these conventional approaches do not provide mechanisms to control the response size precisely. For example, some machine-learning models stop the response midway without completing the text (e.g., with an incomplete sentence or response) or overshoot the length setting by producing longer (and often hallucinated) responses.

In contrast, the described techniques and systems provide generative text filling to automatically provide text responses that fit a new or modified text box. For example, a service provider system implements a text generation service to receive an input that includes a text input and one or more dimensions of a text box. The text input often includes a prompt for a machine-learning model or an example of language for the machine-learning model to edit. In one scenario, the text input includes a request to provide information (e.g., a prompt to learn about a certain topic), expand on a topic or previously written material, summarize selected text (e.g., an email or document), generate a mathematical solution (e.g., a proof or derivation), or create a message (e.g., happy birthday wishes). The dimensions indicates the width and height of a bounding box (e.g., a text box) for the generated text. In some examples, the text input includes a previously generated text response, and the dimensions indicates a new width and/or height for the bounding box.

The text generation service generates a prompt for a machine-learning model based on the received input. An example of the machine-learning model includes a large language model (LLM) that uses the prompt to generate the text for a specified bounding box. A variable response module then processes the generated text to ensure the generated text fits the dimensions. If the generated text is too long or too short, the variable response module prompts the LLM to generate variations of each line or portion of the initial generated response and combines the different variations to present a generated response to the user within the bounding box via the user interface. In contrast to an iterative approach necessitated by conventional approaches to generate texts that fit within a specified text box, the described techniques and systems provide dynamic text generation and editing, where the variable response module and LLM fluidly rewrite text to fit a user-adjustable bounding box. In response to the text area being expanded or contracted, the LLM dynamically rephrases the content to ensure it fits well within the new dimensions of the resized bounding box while preserving the message or intent of the original text.

In one implementation, users can resize a bounding box (e.g., a text box or area) by manipulating its handles, prompting the LLM to rephrase the text to match the new dimensions automatically. The rephrased text maintains the original message's context but scales the detail level up (e.g., added details and explanations) or down (e.g., concise summary) to fit the available space, enhancing aesthetics and readability.

In the following discussion, an example environment is first described that employs examples of techniques described herein. Example procedures are also described which are performable in the example environment and other environments. Consequently, the performance of the example procedures is not limited to the example environment, and the example environment is not limited to the performance of the example procedures.

### Example Text Generation Environment

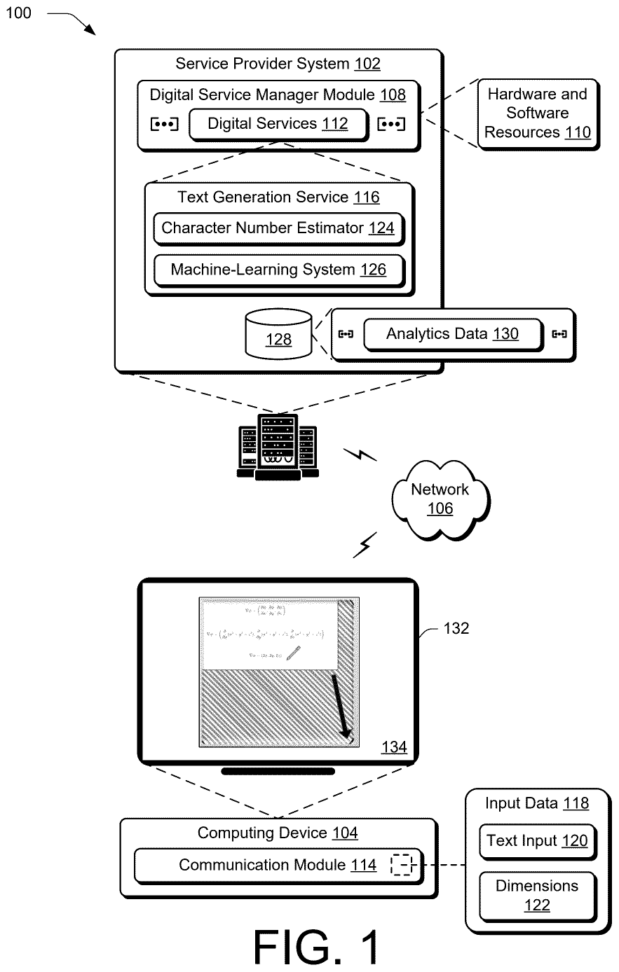

FIG. 1 is an illustration of a digital medium environment 100 in an example implementation that is operable to employ generative text filling as described herein. The illustrated environment 100 includes a service provider system 102 and a computing device 104 that are communicatively coupled, one to another, via a network 106. Computing systems for the service provider system 102 and the computing device 104 are configurable in a variety of ways. For instance, computing device 104 is associated with a user, and service provider system 102 is a remote computing system (e.g., one or more servers) configured to employ the described techniques and systems for caption generation.

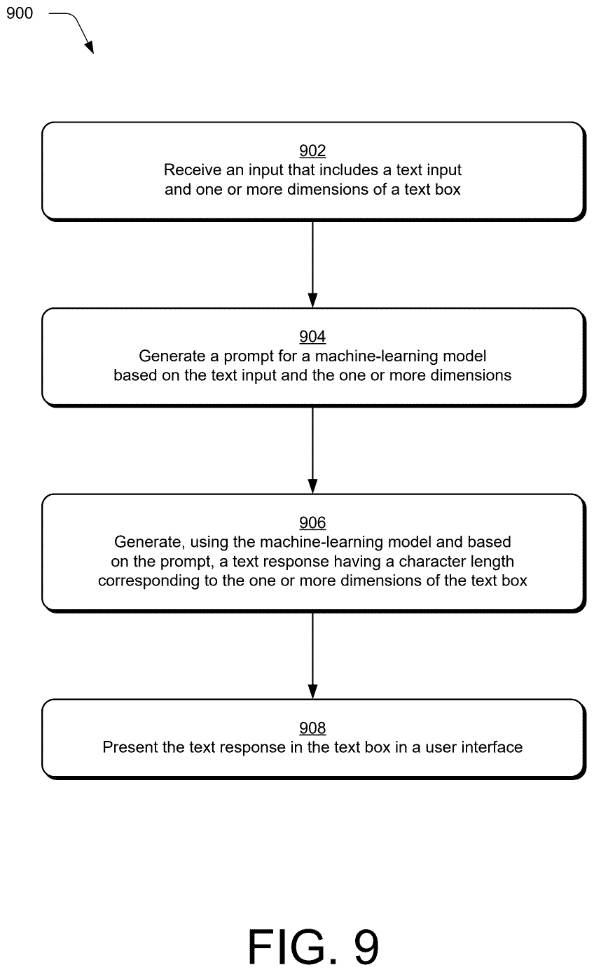

A computing system, for instance, is configurable as a desktop computer, laptop computer, mobile device (e.g., assuming a handheld configuration such as a tablet or mobile phone), server, and so forth. Thus, the service provider system 102 or the computing device 104 is capable of ranging from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described in relation to FIG. 9.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices (e.g., computing device 104).

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a text generation service 116 for writing, shortening, lengthening, or rewriting input data 118 to provide captions. For example, the text generation service 116 is a feature of another digital service 112 (e.g., a digital content creator). A user of the computing device 104 accesses the text generation service 116 utilizing the communication module 114. In response to a prompt or as part of a user interface, the user provides input data 118 to the text generation service 116 via the computing device 104.

The input data 118 includes a text input 120 and a dimensions 122 to be processed for text generation. The text input 120 includes an initial draft of text provided by the user or instructions for the text generation service 116 (e.g., a writing prompt, a summary of other text, or a mathematical equation). The dimensions 122 indicates a bounding or text box within which the text generated by the text generation service 116 is to fit. Potential action requests initiated by the dimensions 122 include generating new text based on the text input 120, shortening the text input 120, lengthening the text input 120, and otherwise editing the text input 120.

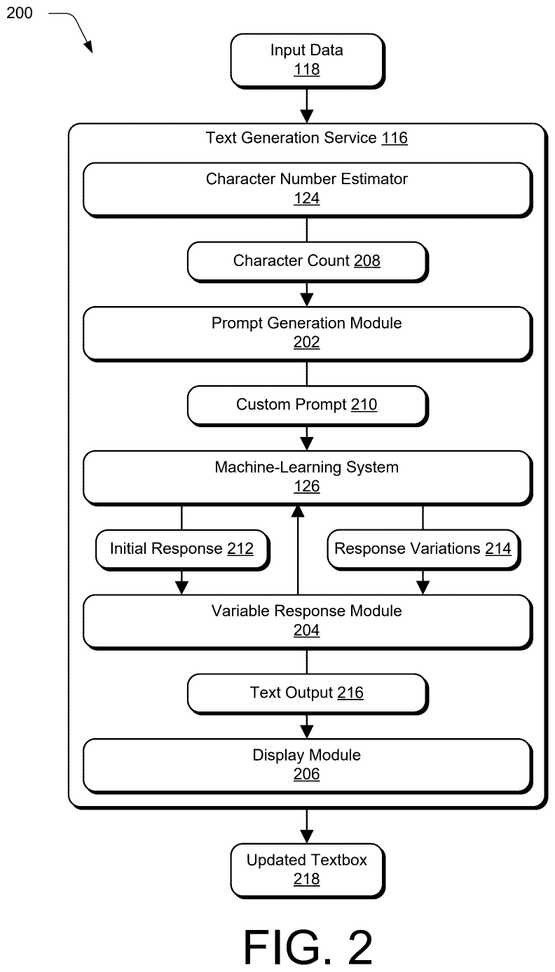

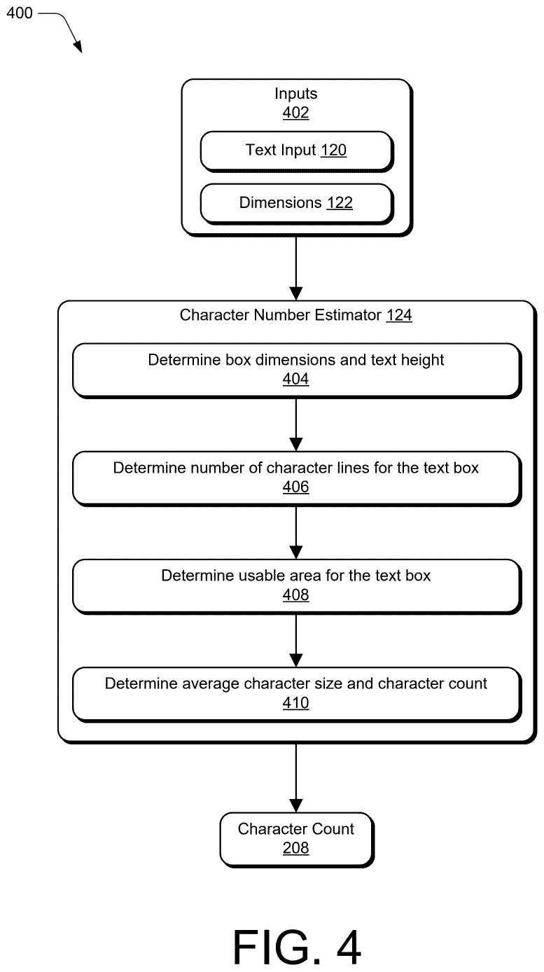

The text generation service 116 utilizes a character number estimator 124 and a machine-learning system 126 to provide the services and techniques described herein. In particular, the text generation service 116 receives the input data 118 and provides or forwards it to the character number estimator 124. The character number estimator 124 processes the dimensions 122 (e.g., the height and width of the user-defined bounding box) and text input 120 to estimate the number of characters that fit within the bounding box to construct a prompt for the machine-learning system 126 as described in greater detail with respect to FIGS. 2 and 4.

The machine-learning system 126 uses a machine-learning model to process the textual prompt with input values and parameters and generate text that fits within the bounding box. The machine-learning model is a computer representation that can be tuned (e.g., trained and retrained) based on inputs to approximate unknown functions. In particular, a machine-learning model utilizes algorithms to learn from and make predictions on known data by analyzing training data to learn and relearn to generate outputs that reflect patterns and attributes of the training data. According to various implementations, the machine-learning model uses supervised, semi-supervised, unsupervised, reinforcement, and/or transfer learning. For example, the machine learning model is capable of including but is not limited to clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. Examples of machine-learning models include neural networks, convolutional neural networks (CNNs), long short-term memory (LSTM) neural networks, decision trees, and so forth.

In one implementation, the machine-learning system 126 uses a large language model (LLM) to generate text. LLMs are machine-learning models designed to understand, generate, and interact with human language inputs at a large scale. These models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

LLMs are configurable to perform a wide range of language-related tasks without being explicitly programmed for each one. These tasks include text generation, translation, summarization, question answering, sentiment analysis, and natural language processing. To train an LLM, the underlying machine-learning model is provided with training data that includes examples of text to train and retrain the model to predict the next word in a sequence. Over time, the model, once trained, is configured to generate text that is coherent and contextually relevant, configurable to mimic the style and content of the training data, and so forth. In this way, LLMs provide a foundational tool in artificial intelligence for understanding and generating human language, powering a wide range of applications from conversational agents to content creation tools.

The service provider system 102 also includes a storage device 128, illustrated to include analytics data 130, which describes historical information about digital content (e.g., digital media and/or associated captions) and interactions with the digital content. For example, analytics data 130 describes digital content distributed and monitored via a content distribution channel or multiple content distribution channels as well as a composition or substance of the digital content (e.g., text, images, colors, intents, etc.), and so forth. Analytics data 130 also describes how the digital content was received via the content distribution channels. Examples of which include the number of times the digital content was viewed, the number of comments received relative to the digital content, the sentiment/context of these comments, whether the digital content was shared or liked and how many times, whether the digital content was rated positively or negatively and how many times, etc.

In an example, the analytics data 130 describes how interactions with the digital content are performed such as tactilely via touch (e.g., using a touchscreen input device), scrolling (e.g., using a mouse input device), keystrokes (e.g., using a keyboard input device), voice commands (e.g., using a microphone input device), and so forth. In this example, the analytics data 130 is capable of describing human-based information about interactions with the digital content, such as eye movements of users (e.g., using gaze tracking), whether the digital content is consumed by a single user or simultaneously by multiple users, etc.

The analytics data 130, for instance, describes information specific to particular distribution channels. For example, this distribution-channel-specific information generalizes observations from particular distribution channels, such as digital content with digital images or a light-hearted or humorous text generally outperforms digital content with relatively long text sequences in particular distribution channels. In another example, the distribution-channel-specific information clarifies differences between observations from particular distribution channels and across many distribution channels based on content length, tonality, and other characteristics. For instance, across many distribution channels, digital content with a positive sentiment generally outperforms digital content with a negative sentiment; however, in a particular distribution channel, digital content with a negative sentiment generally outperforms digital content with a positive sentiment.

Once the text is generated and arbitrated by a variable response module (as described in greater detail with respect to FIG. 2) to ensure the text fits the dimensions 122, the service provider system 102 communicates the generated text to the computing device 104 via the communication module 114. The computing device 104 outputs the generated text to the user via a display device 132 that is communicatively coupled to the computing device 104 via a wired or wireless connection. The service provider system 102 or the text generation service 116 may also communicate a user interface 134 for presenting the generated text within the user-defined text box.

As illustrated in FIG. 1, the service provider system 102 uses inputs received via the user interface 134 of the computing device 104 to generate a textual prompt for a machine-learning system 126. The machine-learning system 126 uses the textual prompt to generate text that fits the text box. In this way, the text generation service 116 enhances the management and display of text in digital layouts by fluidly reshaping text generated by the machine-learning system 126 to fit the user-adjusted text box. In response to the text area being expanded or contracted, the machine-learning system 126 and a variable response module dynamically rephrase the content to ensure it fits within the new dimensions of the bounding box while preserving the message and intent.

In the following discussion, an example system, e.g., the text generation service 116, is first described, employing examples of techniques described herein. Example procedures are also described which are performable in the example system and other systems. Consequently, the performance of the example procedures is not limited to the example system, and the example system is not limited to the performance of the example procedures.

### Example Text Generation System and Techniques

FIG. 2 depicts a system 200 in an example implementation showing the operation of a text generation service 116 of FIG. 1 as employing the techniques described herein. The text generation service 116 is illustrated to include the character number estimator 124, a prompt generation module 202, the machine-learning system 126, a variable response module 204, and a display module 206. The text generation service 116 receives and processes the input data 118, which includes the text input 120 and the dimensions 122, to generate an updated text box 218.

In the example implementation, the character number estimator 124 receives and processes the input data 118 to estimate a character count 208 for the bounding box associated with the dimensions 122. For example, the character number estimator 124 predicts the number of characters that fit within a textbox of a given size corresponding to the dimensions 122 and various character factors to determine a character count 208 for the text box.

Character number estimation is conventionally based on ratios and guesswork. For example, some conventional approaches assume that the character density within a given area remains constant. Accordingly, if the area of the bounding box doubles, these conventional approaches estimate that the number of characters doubles as well. However, this conventional assumption is flawed. For example, if the bounding box changes from 1″×1″ to 2″×1″, the conventional assumption suggests that both textbox configurations should contain the same number of characters. If the box becomes 2″×1″, the characters that can be contained in each row are not simply the previous number times two. Similarly, the number of characters that fit within a 2″×1″ box is generally the same as the number of characters that fit within a 1″×2″ box. The number of characters that can be contained in each line generally increases by more than a factor of two.

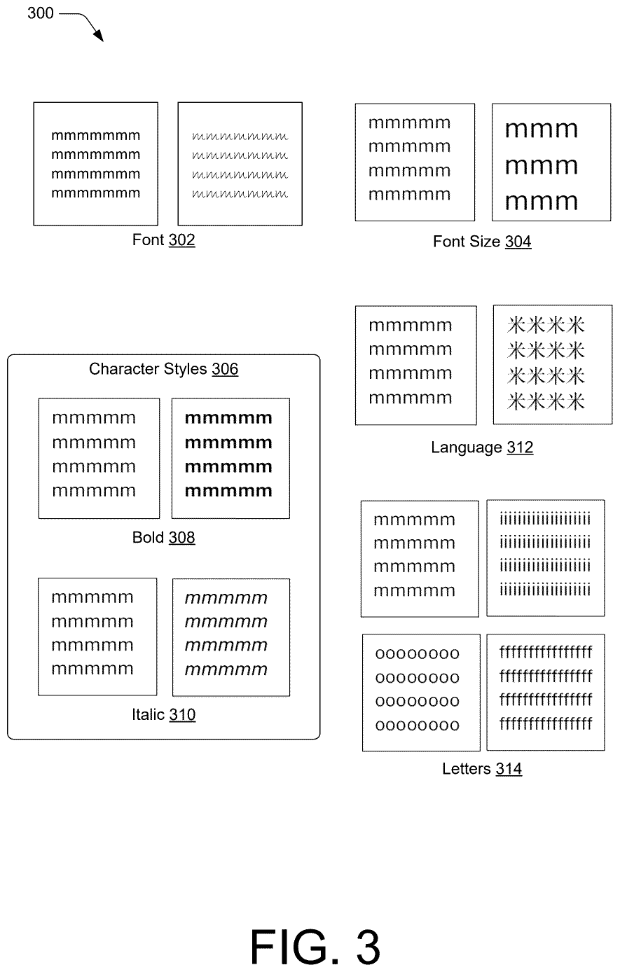

In contrast, the described character number estimator 124 considers multiple factors to generate more accurate estimates. The factors include font, font size, character styles, language, and letters as described in greater detail with respect to FIG. 3. Operation of the character number estimator 124 is described in greater detail with respect to FIG. 4.

FIG. 3 depicts examples 300 of different factors the character number estimator 124 of FIGS. 1 and 2 considers to determine the number of characters within a bounding box. Several factors affect the number of characters that fit within a bounding box, including font 302, font size 304, character styles 306 (e.g., bold 308, italic 310, underline 312), language 312, and letters 314.

As illustrated in FIG. 3, the shape of letters in different fonts 302 is different. For example, ‘M’ can be larger or smaller in different fonts 302, leading to a different number of ‘M’s in a bounding box of the same size. Similarly, the same font 302 but with different font sizes 304 results in different character numbers in the same bounding box.

The character style 306, including bold 308 and italic 310 also affects the character number. For example, if the character style 306 includes bold 308, each character takes up more space, and the number of characters that can be contained in a box may change accordingly. In general, the character number estimator 124 assumes the font 302, font size 304, character styles 306 (e.g., bold 308 and italic 310), and language 312 remain constant or fixed when the text box size changes. The table below summarizes average character size changes based on different character styles:

| Formatting | Width Change | Height Change |
|---|---|---|
| Bold | +10-20% | +2-5% |
| Italic | −5-10% | ±1-3% |
| Bold + Italic | +15-25% | +2-5% |

The size of different characters is generally different in different languages 312. For example, Chinese letters are generally larger than English characters, as illustrated in FIG. 3. The language 312 also impacts the distribution or frequency of different characters. As illustrated as one example in the following table, although English and German languages generally have the same script, these languages have different percentage usages for different characters. Based on different samples of text in the different languages 312, the distribution or frequency of different characters may be updated. For languages like Chinese with several hundred characters, the character distribution is often long-tailed. Because the letters in a given text are generally an equitable mix of characters with different widths and heights, the character number estimator 124 considers the language 312 and the corresponding character distribution. Because the size of letters 314 is generally different, a 1″×1″ box, for example, can hold 20 ‘m’, 80 ‘i’, 32 ‘o’, or 64 ‘f’.

| | | | | Character | Chinese |
|---|---|---|---|---|---|
| Character | English | Character | German | (Top 20) | (Simplified) |
| E | 13.00% | E | 17.40% | [symbol] | 7.00% |
| T | 9.10% | N | 9.78% | — | 3.50% |
| A | 8.20% | I | 7.55% | [symbol] | 3.30% |
| O | 7.50% | S | 7.27% | [symbol] | 2.80% |
| I | 7.00% | R | 6.97% | [symbol] | 2.60% |
| N | 6.70% | A | 6.51% | [symbol] | 2.40% |
| S | 6.30% | T | 6.15% | [symbol] | 2.30% |
| H | 6.10% | D | 5.08% | [symbol] | 2.00% |
| R | 5.90% | H | 4.76% | [symbol] | 1.90% |
| D | 4.30% | U | 3.93% | [symbol] | 1.80% |
| L | 4.00% | L | 3.44% | [symbol] | 1.70% |
| U | 2.80% | C | 3.05% | [symbol] | 1.60% |
| C | 2.80% | M | 2.53% | [symbol] | 1.50% |
| M | 2.40% | B | 1.90% | [symbol] | 1.50% |
| F | 2.20% | G | 1.85% | [symbol] | 1.40% |
| W | 2.10% | F | 1.66% | [symbol] | 1.30% |
| G | 2.00% | P | 1.51% | [symbol] | 1.20% |
| Y | 1.90% | V | 1.08% | [symbol] | 1.10% |
| P | 1.90% | W | 1.05% | [symbol] | 1.10% |
| B | 1.50% | Z | 1.07% | [symbol] | 1.00% |
| V | 1.00% | J | 0.27% | [symbol] | 1.00% |
| K | 0.80% | X | 0.03% | | |
| J | 0.15% | Q | 0.02% | | |
| X | 0.15% | Y | 0.03% | | |
| Q | 0.10% | K | 1.14% | | |
| Z | 0.07% | O | 2.51% | | |
| | | Ä | 0.32% | | |
| | | Ö | 0.30% | | |
| | | Ü | 0.12% | | |
| | | ß | 0.20% | | |

FIG. 4 depicts a system and procedure in an example implementation 400 showing an operation of a character number estimator of FIG. 2 in greater detail as employing the techniques described herein. Based on inputs 402, the character number estimator 124 determines a character count 208. The inputs 402 include the text input 120 and dimensions 122.

To begin, the character number estimator 124 determines box dimensions and text height (block 404). From the dimensions 122, the character number estimator 124 identifies a box height (H_{box}) and box width (W_{box}) to determine a usable area in the text box for the generated text. The usable area determination also considers the margins, if any, for the text box. The margins include a top margin (e.g., a horizontal margin space at the top of the text box), a bottom margin (e.g., a horizontal margin space at the bottom), a left margin (e.g., a vertical margin space on the left side), a right margin (e.g., a vertical margin space of the right side), and line spacing (e.g., horizontal margins in between lines).

The character number estimator 124 determines the number of character lines for the text box (block 406). This determination is based on the box dimensions, top margin, bottom margin, line spacing, and text height. The number of character lines (Nₗᵢₙₑₛ) is determined using the following equation:

$${N}_{l i n e s} = \frac{{H}_{b o x} - 2 {M}_{v e r t i c a l} - ( {N}_{l i n e s} - 1 ) \cdot {M}_{l i n e}}{{H}_{t e x t}}$$

where H_{box} is the height of the text box, M_{vertical} are the vertical margins (e.g., the top and bottom margins assuming equal margins), Mₗᵢₙₑ is the line spacing between lines, and Hₜₑₓₜ is the text height or character line height. In some implementations, the top and bottom margins are not equal and 2M_{vertical} is replaced with the top and bottom margins. The above equation is rewritten as:

$${N}_{l i n e s} = \frac{{H}_{b o x} - 2 {M}_{v e r t i c a l} + {M}_{l i n e}}{{H}_{t e x t} + {M}_{l i n e}}$$

The character number estimator 124 determines the usable area for the text box (block 408). The usable area is calculated as the area of the box minus the unusable area (A_{margin}), which includes the margins (e.g., horizontal and vertical margins) and line spacing. In other words, the usable area is the total area inside the text box that can be used for the text output 216. The usable area is calculated using the following equations:

$${A}_{t e x t} = {H}_{b o x} \cdot {W}_{b o x} - {A}_{m a r g i n}$$

$${A}_{m a r g i n} = 2 {W}_{b o x} \cdot {M}_{v e r t i c a l} + 2 ( {H}_{b o x} - 2 {M}_{v e r t i c a l} ) \cdot {M}_{h o r z} + ( {W}_{b o x} - 2 {M}_{h o r z} ) \cdot ( {N}_{l i n e s} - 1 ) \cdot {M}_{l i n e}$$

where M_{horz} is the horizontal margin (e.g., the left or right margin assuming equal margins). In some implementations, the top and bottom margins and left and right margins are not equal and M_{vertical} and M_{horz} are replaced with an average of the vertical and side margins, respectively.

The character number estimator 124 then determines the average character size and the character count (block 410). The average character size considers the usage distribution of characters in a particular language 312 and calculates the weighted average for the area used by the characters based on the size as determined by the font 302, font size 304, and character styles 306. From the text input 120, the character number estimator 124 finds the font characteristics and identifies the font 302 (e.g., Times New Roman), font size 304 (e.g., 12 point), character styles 306 (e.g., bold 308 and/or italic 310), and language 312 (e.g., English). Based on the font 302, font size 304, character styles 306, and language 312, the average text height (Hₜₑₓₜ) and text width (Wₜₑₓₜ) is determined or retrieved from stored values. The average character size (Aₜₑₓₜ) is calculated using the following equation:

$${A}_{t e x t} = {\sum }_{i = 1}^{n} {H}_{i} \cdot {W}_{i} \cdot {R}_{i}$$

where n is the number of characters or letters in the alphabet for the language 312 (e.g., n equals 26 for English), Hᵢ is the height of each letter, Wᵢ is the width of each letter, and Rᵢ is the letter frequency (e.g., as illustrated in the preceding table with example letter frequency for different languages 312). The character count 208 (N_{char}) is determined using the following equation:

$${N}_{c h a r} = \frac{{H}_{b o x} \cdot {W}_{b o x} - {A}_{m a r g i n}}{{A}_{t e x t}}$$

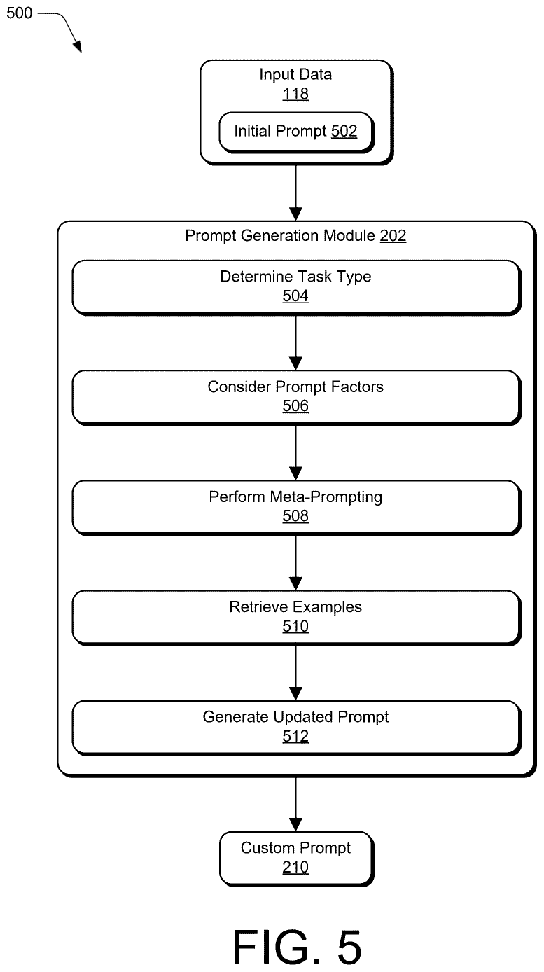

Returning to FIG. 2, the prompt generation module 202 uses the character count 208 and the text input 120 to generate a custom prompt 210 for the machine-learning system 126. As described in detail with respect to FIG. 5, the prompt generation module 202 identifies task type and prompt parameters to craft new and custom prompts corresponding to the specific requirements of the task.

FIG. 5 depicts a system and procedure in an example implementation 500 showing an operation of the prompt generation module 202 of FIG. 2 in greater detail as employing the techniques described herein. The prompt generation module 202 receives an initial prompt 502, which includes the text input 120 and the character count 208. In one implementation, the initial prompt 502 includes a first version of text that fills a text box and the character count 208 (e.g., to lengthen or shorten the first text). In another implementation, the initial prompt 502 includes a prompt for the machine-learning system 126 and the character count.

To begin, the prompt generation module 202 determines a task type associated with the initial prompt 502 (block 504). The text input 120 is categorized into one of several potential task types: informational, creative, precise, mathematical or numerical, combinational, and rewritable. In other implementations, the prompt generation module 202 considers additional task types.

Based on the task type associated with the text input 120, the prompt generation module 202 considers prompt factors in generating the custom prompt 210 (block 506). Each task type is associated with one or more factors that determine the response's role, rules, and/or tone. For example, an informational task generally involves a formal and informative tone focusing on providing accurate information. In contrast, a creative task allows for more flexibility in format and creativity, emphasizing sparking the imagination. Example prompt parameters include role, tone, format, creativity, temperature, length, content, number of lines, and retrieved task-specific examples.

The prompt generation module 202 then uses one or more prompt factors to perform meta-prompting based on the specific requirements of the identified task type (block 508). Meta-prompting involves using the initial prompt 502 to generate the custom prompt 210 by outlining the desired structure or format for the custom prompt 210. In other words, the prompt generation module 202 tailors the custom prompt 210 to the identified task type. For example, if the task type is mathematical or numerical, the prompt generation module 202 generates a prompt that focuses on solving a mathematical equation or providing numerical data to tailor the response to the user's needs. As another example, if the task type is creative, the custom prompt 210 suggests a more conversational tone.

The prompt generation module 202 also retrieves examples to provide context and inspiration for the response (block 510). The examples are generally categorized by task type, which allows relevant examples to be utilized for response generation. For example, if the task type is rewritable, examples of rewritten texts are retrieved that demonstrate different tone and format options.

Combining meta-prompting with example retrieval, the prompt generation module 202 generates an updated prompt (block 512). The updated prompt is output as custom prompts 210, leading to more accurate, engaging, and tailored responses from the machine-learning system 126. In other words, the prompt generation module 202 creates custom prompts 210 that cause the machine-learning system 126 to generate engaging, informative content that effectively communicates the user's message. In this way, the text generation service 116 helps users overcome writer's block and generate refined ideas, clarified thoughts, and more expressive content.

Returning to FIG. 2, the machine-learning system 126 receives the custom prompt 210 and generates an initial response 212. In one example, the machine-learning system 126 is a large language model (LLM).

Conventional generational models trained on world knowledge often struggle to generate content tailored to the user's request because conventional models provide little to no control over the output. To address this problem, the described text generation service 116 utilizes a custom dataset based on user preferences to fine-tune the LLM and improve the quality of generated responses. The machine-learning system 126 uses direct preference optimization (DPO) for fine-tuning with the reasoning that different task types have different preferred outcomes. DPO techniques are used to align the one or more LLMs of the machine-learning system 126 with human preferences for the different task types identified by the prompt generation module 202. In particular, DPO directly updates the weights of the LLMs based on user preferences, with the dataset including an input prompt and two variations of the generated response. For example, a dataset of approximately 1000 samples is manually annotated by potential users of the text generation service 116 to understand user preferences for different task types based on the selected and rejected variations. In one implementation, the LLM is fine-tuned assuming user preferences for different categories of tasks is consistent across users. For example, the fine-tuning includes user preferences of an informative responses for mathematical-based tasks and creative responses for birthday wishes.

While the prompt generation module 202 sorts the tasks into distinct categories, the user's request often overlaps multiple categories. For example, if the user prompts “why is the sky blue?,” the tasks different depending on the character count 208. If the character count 208 is 500 characters, providing an informative response usually satisfies the user's request. However, if the character count 208 is 1,000 characters, the prompt generation module 202 blends an informational task type with a creative task to provide a more verbose, intriguing response.

The machine-learning system 126 provides the initial response to the variable response module 204. The variable response module 204 ensures the generated content is moderated or adjusted in terms of the number of characters (e.g., the character count 208) to fit the text box associated with the dimensions 122.

Conventional techniques provide ad hoc and limited control over the length of outputs from a machine-learning model (e.g., an LLM). For example, many conventional techniques allow users to request shorter or longer responses but do not provide character-number control. Other conventional techniques allow users to set maximum character or word limits, but such approaches often cut responses off mid-sentence. Yet another conventional technique allows tuning to minimize the entropy of character count in generated responses but still fails to guarantee the output to be in a bounded range of characters.

In contrast, the described variable response module 204 provides a dynamic, programming-based approach to provide more control over the character length of the output from the machine-learning system 126 without compromising quality. In particular, the variable response module 204 generates variations of the initial response 212 from the machine-learning system 126 based on the knapsack problem to obtain a deterministic and bounded range of deviation from the character count 208. In this way, the variable response module 204 offsets the randomness inherent in the machine-learning system 126 while maintaining consistent quality.

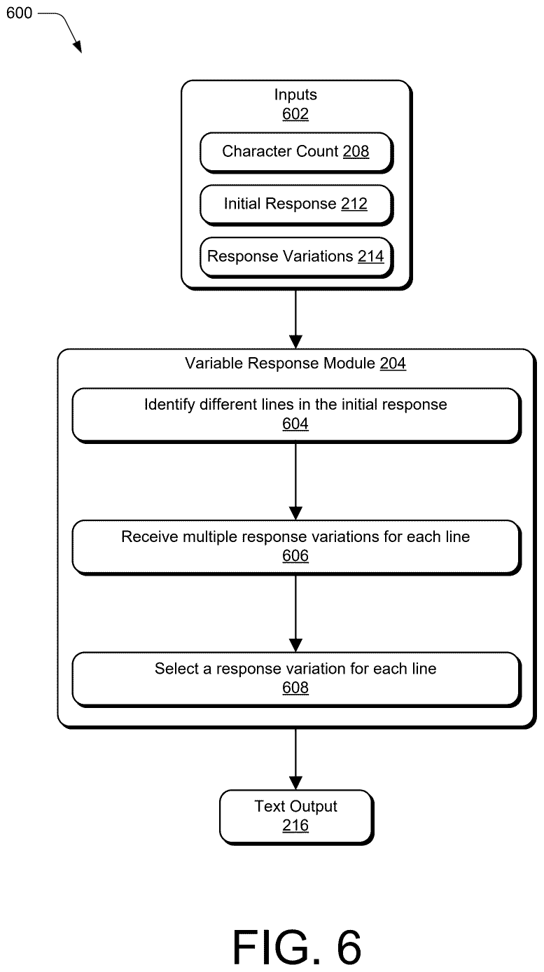

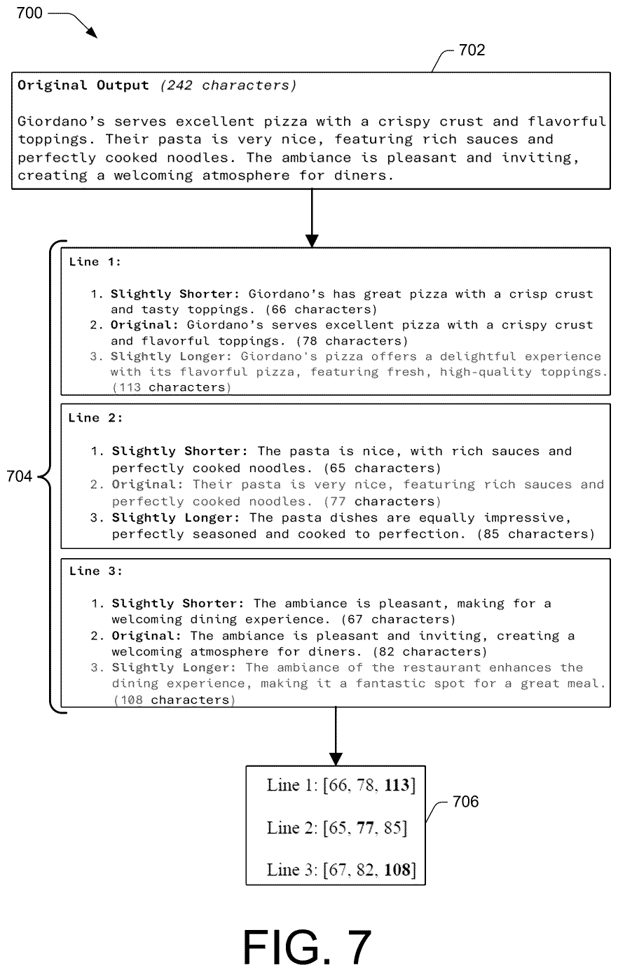

FIG. 6 depicts a system and procedure in an example implementation 600 showing an operation of the variable response module 204 of FIG. 2 in greater detail as employing the techniques described herein. FIG. 7 illustrates an example 700 of an initial response and response variations to generate a text output that fits a text box in accordance with techniques described herein.

In implementation 600, the variable response module 204 initially receives input 602, which includes the character count 208 and the initial response 212 from the machine-learning system 126. In many scenarios, the initial response 212 does not match the character count 208 and does not fit well within the text box associated with the dimensions 122. If the initial response has a character count with a difference from the (desired) character count 208 that exceeds a predetermined threshold, the variable response module 204 proceeds with the procedure illustrated in implementation 600. The predetermined threshold, for example, is an absolute value (e.g., 50 characters) or a relative value (e.g., five percent). As a result, if the difference of the initial response 212 from the character count 208 exceeds the predetermined threshold (e.g., more than 50 characters or more than 5% difference), the variable response module 204 proceeds to generate the response variations as described in greater detail below.

In FIG. 7, the machine-learning system 126 is prompted to “Expand the following food review in 300 characters. Giordano's pizza: good pizza, fresh toppings, great spaghetti. Overall, delicious food and nice ambiance.” As mentioned in the prompt, the requested character count 208 is 300 characters. The original output 702 from the machine-learning system is the following: “Giordano's serves excellent pizza with a crispy crust and flavorful toppings. Their pasta is very nice, featuring rich sauces and perfectly cooked noodles. The ambiance is pleasant and inviting, creating a welcoming atmosphere for diners.” The original output 702 includes 242 characters, which is 58 characters short of the desired length.

The variable response module 204 identifies different lines in the initial response 212 (block 604). The lines include sentences, bullet points, equations, or other units of the initial response 212. In example 700, the variable response module 204 identifies the three sentences as lines.

The variable response module 204 then iterates each line of the initial response 212 to receive multiple response variations 214 for each line (block 606). In one implementation, each line is sent through the machine-learning system 126 to generate two versions of the same line: a (slightly) shorter and a (slightly) longer variation. Accordingly, the text generation service 116 avoids losing or adding content; instead, the content of each line is expressed with different verbosity or number of words. In other implementations, the variable response module 204 prompts the machine-learning system 126 to generate fewer or more variations of each line. For example, if the initial response 212 is far too short (e.g., more than twenty percent short), the variable response module 204 prompts the machine-learning system 126 to generate line variations that are slightly longer (e.g., about ten percent longer) and much longer (e.g., at least twenty-five percent longer).

In example 700, the response variations 704 include the following lines:

### Line 1:

1. Slightly Shorter: Giordano's has great pizza with a crisp crust and tasty toppings. (66 characters)
2. Original: Giordano's serves excellent pizza with a crispy crust and flavorful toppings. (78 characters)
3. Slightly Longer: Giordano's pizza offers a delightful experience with its flavorful pizza, featuring fresh, high-quality toppings. (113 characters)

### Line 2:

1. Slightly Shorter: The pasta is nice, with rich sauces and perfectly cooked noodles. (65 characters)
2. Original: Their pasta is very nice, featuring rich sauces and perfectly cooked noodles. (77 characters)
3. Slightly Longer: The pasta dishes are equally impressive, perfectly seasoned and cooked to perfection. (85 characters)

### Line 3:

1. Slightly Shorter: The ambiance is pleasant, making for a welcoming dining experience. (67 characters)
2. Original: The ambiance is pleasant and inviting, creating a welcoming atmosphere for diners. (82 characters)
3. Slightly Longer: The ambiance of the restaurant enhances the dining experience, making it a fantastic spot for a great meal. (108 characters)

In response to receiving the response variations 214 for each line, the variable response module 204 selects a response variation 214 for each line so that the selected response variations have a total length near the character count 208 (block 608). The variable response module 204 uses a dynamic algorithm to reduce the selection to a deterministic problem to achieve the character sum closest to the character count 208. The selection process is constrained by choosing at most one option from the response variations 214 for each line. The variable response module 204 uses a two-dimensional dynamic programming algorithm with the states being the number of lines N (e.g., N=3 in example 700) and the sum of characters (C) for the combined response of selected variations. The time complexity of the selection algorithm is O(N·C), where N is the number of lines of the initial response 212 and C is the number of required characters in the text output 216 (e.g., 300 characters in example 700).

Because each response variation 214 in each line conveys the same meaning, the variable response module 204 selects one response variation 214 for each line while preserving the content or message of the initial response 212. The optimal answer is the closest sum of response variations 214 to the character count 208, which is output by the variable response module 204 as the text output 216.

In example 700, the machine-learning system 126 generates response variations 214 with the following character-length arrays 706: Line 1 [66, 78, 113], Line 2 [65, 77, 85], and Line 3 [67, 82, 108]. From the character-length arrays 706, the variable response module 204 identifies the optimal selection as the longer variation of lines 1 and 3 and the original version of line 2. The selected response variations 214 sum to 298 characters, much closer to the required output of 300 characters than the original output 702.

The display module 206 renders or presents the text output 216 in the user interface 134 of the display device 132 as an updated text box 218. In some implementations, the user can provide a new text input 120 by modifying the text within the text box or a new dimensions 122 by moving or adjusting the handles of the bounding box associated with the text box via the user interface 134.

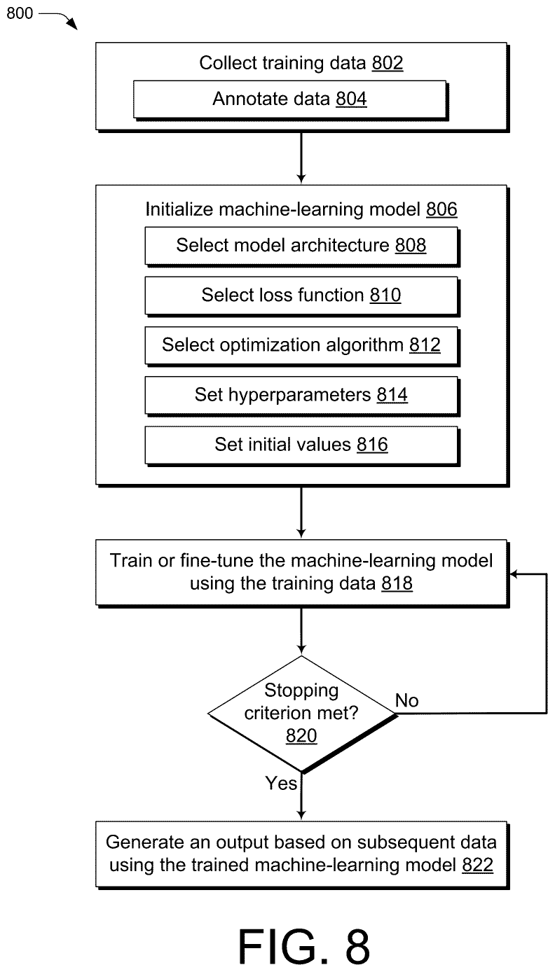

FIG. 8 is a flow diagram depicting an algorithm as a step-by-step procedure 800 in an example implementation of operations performable for training a machine-learning model of the machine-learning system 126 of FIG. 1. The procedure 800 provides one or more examples of generating training data, use of the training data to train a machine-learning model, and use of the trained machine-learning model to perform a task.

To begin in this example, the machine-learning system 126 collects training data (block 802) to be used as a basis to train, optimize, or fine-tune a machine-learning model, i.e., which defines what is being modeled. The training data is collectible by the machine-learning system 126 from a variety of sources, including the DPO dataset described in related to FIG. 2. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques (e.g., DPO techniques) to expand and diversify available training data, balancing techniques to balance several positive and negative examples, and so forth. As described above, the training data is annotated by representative users to optimize or fine-tune a previously, trained machine-learning model.

The machine-learning system 126 is also configurable to identify relevant features to a task type for which the machine-learning model is to be trained. Task examples include classification, natural language processing, generative artificial intelligence, recommendation engines, reinforcement learning, clustering, and so forth. To do so, the machine-learning system 126 collects the training data based on the identified features and/or filters the training data based on the identified features after collection. The training data is then utilized to train a machine-learning model or optimize or fine-tune a previously-trained machine-learning model.

In order to train the machine-learning model in the illustrated example, the machine-learning model is first initialized (block 806). Initialization of the machine-learning model includes selecting a model architecture (block 808) to be trained. Examples of model architectures include large language models (LLMs), neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model uses an LLM to understand, generate, and interact with human language inputs (e.g., custom prompts 210). These machine-learning models are trained on vast amounts of text data using deep learning techniques (e.g., neural networks) to learn patterns, nuances, and the structure of language. The term “large” in LLMs refers to the training data's size and the neural networks' complexity and scale, which may include billions or even trillions of parameters.

As described above, LLMs are configurable to perform a wide range of language-related tasks without being explicitly programmed for each one. To train the LLM, the underlying machine-learning model is provided with training data that includes examples of text to train and retrain the model to predict the next word in a sequence. Over time, the model, once trained, is configured to generate text that is coherent, contextually relevant, and mimics the style and content of the training data, and so forth.

A loss function is also selected (block 810). The loss function is utilized to measure a difference between an output of the machine-learning model (i.e., predictions) and target values (e.g., as expressed by the training data) to be used to train the machine-learning model. Additionally, an optimization algorithm is selected (812) to be used in conjunction with the loss function to optimize parameters of the machine-learning model during training, examples of which include DPO, gradient descent, stochastic gradient descent (SGD), and so forth.

Initialization of the machine-learning model further includes setting hyperparameters and initial values of the machine-learning model (blocks 814 and 816), examples of which include initializing weights and biases of nodes to improve efficiency in training and computational resource consumption as part of training. Hyperparameters are also set to control the training of the machine learning model, examples include regularization parameters, model parameters (e.g., a number of layers in a neural network), learning rate, batch sizes selected from the training data, and so on. The hyperparameters are set using various techniques, including the use of a randomization technique, the use of heuristics learned from other training scenarios, and so forth.

The machine-learning model is then trained, optimized, and/or fine-tuned using the training data, including annotated training data, (block 818) by the machine-learning system 126. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from and make predictions on known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” DPO techniques, and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 820), which is used to validate the model. The stopping criterion is usable to reduce the overfitting of the machine-learning model, reduce computational resource consumption, and promote the ability of the machine-learning model to address previously unseen data (e.g., data not included specifically as an example in the training data). Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 820), the procedure 800 continues training of the machine-learning model using the training data (block 818) in this example.

If the stopping criterion is met (“yes” from decision block 820), the trained machine-learning model is then utilized to generate an output based on subsequent data (block 822) (e.g., to generate the initial response 212 and response variations 214 of FIG. 2). The trained machine-learning model, for instance, is trained to perform a task as described above and therefore once trained is configured to perform that task based on subsequent data received as input and processed by the machine-learning model.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Text Generation Procedure

The following discussion describes techniques that are implementable utilizing the previously described systems and devices. Aspects of the procedure are implementable in hardware, firmware, software, or a combination thereof. The procedure is illustrated as a set of blocks that specify operations performed by one or more devices and are not necessarily limited to the orders shown for performing the operations by the respective blocks. In portions of the following discussion, reference is made to FIGS. 1 through 8. FIG. 9 is a flow diagram depicting a procedure 900 in an example implementation in which generative text filling is performed.

An input, including a text input and one or more dimensions of a text box, is received via a user interface (block 902). For example, the service provider system 102 receives the input data 118 via the user interface 134 of the computing device 104. The text input 120 indicates the original text to be rewritten (e.g., lengthened or shortened) or a natural language prompt or request for text generation. The dimensions 122 indicates a height and width for the text box in which the generated text is to be inserted.

In a first scenario, the text input 120 includes first text included in a first text box. The dimensions 122 includes the dimensions of a second text box that has a different size than the first text box (e.g., a different height and/or width). For example, the dimensions of the second text box are generated via the user interface by the user dragging or moving handles associated with the first text box or a bounding box thereof. In another example, the user utilizes a UI element to change the dimensions of the first text box. The machine-learning system 126 then automatically generates the second text that fits the dimensions of the second text box.

In a second scenario, the text input 120 includes a writing prompt for the machine-learning system 126. The writing prompt is received via a typed text or audio input. The dimensions 122 includes the dimensions of the text box in which the generated text is to be inserted.

A prompt is generated for a machine-learning model based on the text input and the one or more dimensions (block 904). For example, the prompt generation module 202 uses the text input 120 and dimensions 122 to generate a custom prompt 210 for the machine-learning system 126. Based on the prompt, the machine-learning model (e.g., an LLM) generates a text response having a character length corresponding to one or more dimensions of the text box (block 906). Based on the text box dimensions, font, and font size of the text, the text generation service 116 estimates the character count 208 for the text box and uses the variable response module 204 to construct a text output 216 that (nearly) matches the character count 208. In another implementation, the variable response module 204 compares the physical length of the initial response 212, response variations 214, or text output 216 to the usable area associated with the text box to determine whether the generated text fits the user-defined text box. The machine-learning system 126 is trained to maintain a tone, style, or messaging of the text input 120. The generated text response in the text box is then presented to a user via the user interface (block 908).

### Example System and Device

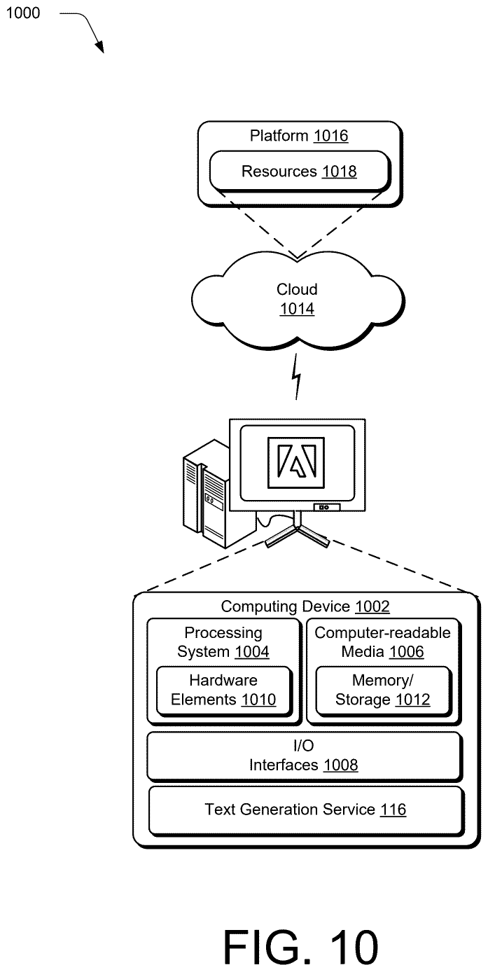

FIG. 10 illustrates an example system 1000 that includes an example computing device that is representative of one or more computing systems and/or devices that are usable to implement the various techniques described herein. This is illustrated through the inclusion of the text generation service 116. The computing device 1002 includes, for example, a server of a service provider, a device associated with a client (e.g., a client device), an on-chip system, and/or any other suitable computing device or computing system.

The example computing device 1002, as illustrated, includes a processing system 1004, one or more computer-readable media 1006, and one or more I/O interfaces 1008 that are communicatively coupled, one to another. Although not shown, the computing device 1002 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing system 1004 is representative of the functionality to perform one or more operations using hardware. Accordingly, the processing system 1004 is illustrated as including hardware elements 1010 that are configured as processors, functional blocks, and so forth. This includes example implementations in hardware as an application specific integrated circuit or other logic device formed using one or more semiconductors. The hardware elements 1010 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1006 is illustrated as including memory/storage 1012. Memory/storage 1012 represents memory or storage capacity associated with one or more computer-readable media. In one example, the memory/storage 1012 includes volatile media (such as random access memory (RAM)) and/or nonvolatile media (such as read-only memory (ROM), Flash memory, optical disks, magnetic disks, and so forth). In another example, the memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways, as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 1002, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 1010. For example, the computing device 1002 is configured to implement particular instructions and/or functions corresponding to the software and/or hardware modules. Accordingly, implementation of a module that is executable by the computing device 1002 as software is achieved at least partially in hardware, e.g., through the use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supportable by various configurations of the computing device 1002 and are not limited to the specific examples of the techniques described herein. This functionality is also implementable entirely or partially through the use of a distributed system, such as over a “cloud” 1014, as described below.

The cloud 1014 includes and/or is representative of a platform 1016 for resources 1018. The platform 1016 abstracts the underlying functionality of hardware (e.g., servers) and software resources of the cloud 1014. For example, the resources 1018 include applications and/or data that are utilized while computer processing is executed on servers remote from the computing device 1002. In some examples, the resources 1018 also include services provided over the Internet and/or through a subscriber network, such as a cellular or Wi-Fi network.

The platform 1016 abstracts the resources 1018 and functions to connect the computing device 1002 with other computing devices. In some examples, the platform 1016 also serves to abstract scaling of resources to provide a corresponding level of scale to encountered demand for the resources implemented via the platform. Accordingly, in an interconnected device embodiment, the implementation of functionality described herein is distributable throughout the system 1000. For example, the functionality is implementable in part on the computing device 1002 as well as via the platform 1016 that abstracts the functionality of the cloud 1014.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, an input via a user interface, the input including a text input and one or more dimensions of a text box;
generating, by the processing device and based on the text input and the one or more dimensions, a prompt for a machine-learning model;
generating, using the machine-learning model and based on the prompt, a text response having a character length corresponding to the one or more dimensions of the text box; and
presenting, by the processing device, the text response inside the text box via the user interface.

2. The method of claim 1, wherein:
the text input comprises first text included in a first text box;
the one or more dimensions comprise the one or more dimensions of a second text box; and
the text response comprises second text having a character length corresponding to the one or more dimensions of the second text box.

3. The method of claim 2, wherein the one or more dimensions are generated via the user interface by dragging or moving handles associated with a bounding box for the first text box.

4. The method of claim 3, wherein the text response is generated automatically in response to the handles associated with the bounding box being dragged or moved.

5. The method of claim 1, wherein the text input comprises a writing prompt for the machine-learning model.

6. The method of claim 1, wherein the machine-learning model comprises a large language model that is fine-tuned using direct preference optimization.

7. The method of claim 6, wherein the prompt for the large language model is generated using meta-prompting based on a task type and prompt factors associated with the text input.

8. The method of claim 1, wherein the method further comprises estimating a character count for the text box based on the one or more dimensions of the text box, margins for the text box, and font characteristics of the text input.

9. The method of claim 8, wherein the font characteristics of the text input include at least two of a font, a font size, one or more character style, a language, and a letter frequency.

10. The method of claim 9, wherein estimating the character count for the text box comprises:
determining, based on a height of the text box, vertical margins of the text box, line spacing between character lines, and a height of text input or the character lines, a number of character lines for the text box;
determining, based on the height and a width of the text box, the vertical margins and horizontal margins of the text box, the number of character lines, and the line spacing, a usable area for the text box;
determining, based on a height, a width, and letter frequency of each letter in the language, an average character size; and
determining the character count as the usable area for the text box divided by the average character size.

11. The method of claim 8, wherein generating the text response for the text box comprises:
generating, by the machine-learning model, a first text response having a first character length;
in response to the first character length having a difference from the character count for the text box that is greater than a predetermined threshold, identifying one or more initial lines of the first text response;
for each line of the one or more initial lines of the first text response, generating, by the machine-learning model, at least one longer variation and at least one shorter variation of each line; and
for each line of the one or more initial lines, selecting one of the at least one longer variation, the at least one shorter variation, or an initial line to construct a second text response, the second text response having a second character length closest to the character count for the text box among possible line combinations.

12. The method of claim 1, wherein the machine-learning model is trained to maintain a tone, a style, or messaging of the text input.

13. A system comprising:
a memory component; and
one or more processing devices coupled to the memory component, the one or more processing devices to perform operations comprising:
receiving, via a user interface, first text inside a first text box and dimensions of a second text box, the dimensions of the second text box different than those of the first text box;
generating, based on the first text and the dimensions of the second text box, a prompt for a machine-learning model;
generating, using the machine-learning model and based on the prompt, second text for the second text box having a character length corresponding to the dimensions of the second text box; and
presenting the second text inside the second text box via the user interface.

14. The system of claim 13, wherein the second text is generated automatically in response to handles associated with the first text being dragged or moved.

15. The system of claim 13, wherein the one or more processing devices perform an additional operation comprising:
estimating a character count for the second text box based on the dimensions of the second text box, margins for the second text box, and font characteristics of the first text that include at least two of a font, a font size, one or more character style, a language, and a letter frequency.

16. The system of claim 15, wherein the one or more processing devices estimate the character count for the second text box by performing additional operations comprising:
determining, based on a height of the second text box, vertical margins of the second text box, line spacing between character lines, and a height of the first text or the character lines, a number of character lines for the second text box;
determining, based on the dimensions of the second text box, the vertical margins of the second text box, horizontal margins of the second text box, the number of character lines, and the line spacing, a usable area for the second text box;
determining, based on a height, a width, and letter frequency of each letter in the language, an average character size; and
determining the character count as the usable area for the second text box divided by the average character size.

17. The system of claim 16, wherein the one or more processing devices generate the second text for the second text box by performing additional operations comprising:
generating, by the machine-learning model, a first text response having a first character length;
in response to the first character length having a difference from the character count for the second text box that is greater than a predetermined threshold, identifying one or more initial lines of the first text response;
for each line of the one or more initial lines of the first text response, generating, by the machine-learning model, at least one longer variation and at least one shorter variation of each line; and
for each line of the one or more initial lines, selecting one of the at least one longer variation, the at least one shorter variation, or an initial line to construct the second text, the second text having a second character length closest to the character count for the second text box among possible line combinations.

18. A non-transitory computer-readable storage medium storing executable instructions, which when executed by a processing device, cause the processing device to perform operations comprising:
receiving, via a user interface, an input that includes a text input and one or more dimensions of a text box;
determining, based on the one or more dimensions and the text input, a character count for the text box;
generating, based on the text input and the character count, a prompt for a machine-learning model;
generating, using the machine-learning model and based on the prompt, a text response for the text box having a character length substantially matching the character count; and
presenting, via the user interface, the text response inside the text box.

19. The non-transitory computer-readable storage medium of claim 18, wherein the non-transitory computer-readable storage medium stores additional executable instructions, which when executed by the processing device, cause the processing device to estimate the character count for the text box by performing additional operations comprising:
determining, based on a height of the text box, vertical margins of the text box, line spacing between character lines, and a height of the character lines, a number of character lines for the text box;
determining, based on the one or more dimensions of the text box, vertical margins of the text box, horizontal margins of the text box, the number of character lines, and the line spacing, a usable area for the text box;
determining, based on a height, a width, and letter frequency of each letter in a language of the text input, an average character size; and
determining the character count as the usable area for the text box divided by the average character size.

20. The non-transitory computer-readable storage medium of claim 19, wherein the non-transitory computer-readable storage medium stores additional executable instructions, which when executed by the processing device, cause the processing device to generate the text response for the text box by performing additional operations comprising:
generating, by the machine-learning model, a first text response having a first character length;
in response to the first character length having a difference from the character count for the text box that is greater than a predetermined threshold, identifying one or more initial lines of the first text response;
for each line of the one or more initial lines of the first text response, generating, by the machine-learning model, at least one longer variation and at least one shorter variation of each line; and
for each line of the one or more initial lines, selecting one of the at least one longer variation, the at least one shorter variation, or an initial line to construct the text response for the text box, the text response having a second character length closest to the character count for the text box among possible line combinations.
